(19) United States
(12) Patent Application Publication
(10) Pub. No.: US 2026/0186396 A1
(43) Pub. Date: Jul. 2, 2026

(54) VIDEO PROJECTION LAMP

(71) Applicant: TAOTAO CHEN, Pingjiang County (CN)

(72) Inventor: TAOTAO CHEN, Pingjiang County (CN)

(21) Appl. No.: 19/004,226

(22) Filed: Dec. 28, 2024

(51) Int. Cl. G03B 21/20; G03B 21/14; G06V 40/10

(52) U.S. Cl. CPC G03B 21/2053; G03B 21/145; G06V 40/103

(57) ABSTRACT

Disclosed is a video projection lamp. The video projection lamp includes a projector body, where the projector body includes a lens arranged at a front end of the projector body, a human body induction probe and a control panel arranged inside the projector body, a projection lamp is arranged inside the lens, the projection lamp and the human body induction probe are electrically connected to the control panel, the human body induction probe is used for detecting a person approaching at a set distance, and the control panel receives a detection signal of the human body induction probe, so as to adjust and reduce brightness of the projection lamp inside the lens or turn off the projection lamp.

### TECHNICAL FIELD

The present disclosure relates to the technical field of projection lamps, and in particular to a video projection lamp.

### BACKGROUND

Today, the demand for dynamic visual effects is increasing in the fields such as indoor and outdoor decoration, commercial display, stage performance, and home entertainment. A traditional lighting lamp can only provide a single lighting function, and cannot satisfy the requirements of diversified scenes. Although an existing projection device can project images, the defects of a large size, inconvenient mounting, high energy consumption, and strict requirements on a projection environment still exist. For example, in the window display of some small shops, a large-scale projection device not only occupies too much space, but also is complex to mount and debug, and has a high cost, which limits its wide application. However, for such a video projection lamp, it is inconvenient to adjust a pitch angle of a projector body according to the use demand, and also inconvenient to adjust a rotation angle of the projector body.

At present, there are a lot of small-sized video projection lamps on the market. Since the small-sized video projection lamps are of a fixed design, a rotating bracket is usually needed to complete operations such as rotation, and adjustment of a direction and a pitch angle. Moreover, since light of the video projection lamp is very bright, when a person approaches the video projection lamp, the light is particularly dazzling, and improvements need to be done.

### SUMMARY

An objective of the present disclosure is to provide a video projection lamp, aiming at solving the problems that for an existing video projection lamp, it is inconvenient to adjust a pitch angle of a projector body according to the use demand, and also inconvenient to adjust a rotation angle of the projector body, and light is dazzling when a person approaches the video projection lamp.

The present disclosure is implemented as follows:

A video projection lamp includes a projector body, and the projector body includes a lens arranged at a front end of the projector body, a human body induction probe and a control panel arranged inside the projector body. A projection lamp is arranged inside the lens, and the projection lamp and the human body induction probe are electrically connected to the control panel. The human body induction probe is used for detecting a person approaching at a set distance, and the control panel receives a detection signal of the human body induction probe, so as to adjust and reduce brightness of the projection lamp inside the lens or turn off the projection lamp.

Preferably, a base is connected to a bottom end of the projector body, and a pitch angle of the projector body is capable of being adjusted relative to the base.

Preferably, the base includes a housing, a supporting rod, a rotating disc and a bottom cover, where a bottom end of the supporting rod passes through the housing and is connected to the rotating disc, the supporting rod is rotationally connected to the housing in coordination with a structure of the rotating disc, and the bottom cover is fixed at a bottom end of the housing through bolts.

Preferably, a key area is arranged at one side of the front end of the projector body, heat dissipation holes are provided at a top of a back of the projector body, and a switching port is provided at a bottom of the back of the projector body.

Preferably, a side surface of the housing is provided with a power socket, a switching hole is provided at a middle of the housing, an inner edge of the housing is provided with a plurality of connecting posts, and the middle of each connecting post is provided with a connecting groove.

Preferably, a connecting hole is provided at a top end of the supporting rod, and a threading hole is provided at a middle of the supporting rod. An insertion ring is arranged at a bottom of the supporting rod, the insertion ring passes through the switching hole, and a plurality of mounting grooves are provided at an inner edge of the insertion ring.

Preferably, a plurality of passing holes are provided at the positions, aligned with the mounting grooves, of the rotating disc, bolts pass through the passing holes and are in threaded connection to the mounting grooves, and a wire passing hole is provided at a middle of the rotating disc.

Preferably, a plurality of bolt holes are provided at the positions, aligned with the connecting grooves, of the bottom cover, the bottom cover and the housing are connected through bolts, and rubber pads are arranged at the positions, aligned with the bolt holes, of a bottom of the bottom cover.

Preferably, a first limiting platform is arranged at the position, along an edge of the switching hole, inside the housing, a second limiting platform is arranged at an edge of the rotating disc, and the first limiting platform and the second limiting platform interfere with each other after the supporting rod rotates by a certain angle in cooperation with the structure of the rotating disc, so as to solve the problem that the supporting rod rotates continuously in cooperation with the structure of the rotating disc, causing a wire inside the threading hole to be twisted.

Compared with the prior art, the present disclosure has the beneficial effects as follows:
1. According to the present disclosure, the human body induction probe is arranged on the projector body, and when a person approaches, the control panel adjusts and reduces brightness of the projection lamp inside the lens, and the projection lamp is turned off when necessary, such that the purpose of protecting eyes is achieved.
2. According to the present disclosure, the base is mounted at the bottom of the projector body, such that the pitch angle of the projector body can be adjusted. Moreover, an upper portion of the base can rotate, such that the rotation angle of the projector body can be adjusted by rotating the upper portion of the base, the projector body can be conveniently adjusted according to the use demand, and the flexibility of the projector body is greatly improved.

### BRIEF DESCRIPTION OF THE DRAWINGS

FIG. 1 is a schematic structural diagram from an obliquely top view at a front end of the whole of the present disclosure.

FIG. 2 is a schematic structural diagram from an obliquely upward view at a rear end of the whole of the present disclosure.

FIG. 3 is a schematic structural diagram from an obliquely top view at a front end of a projector body of the present disclosure.

FIG. 4 is a schematic structural diagram from an obliquely top view at a rear end of a projector body of the present disclosure.

FIG. 5 is an exploded schematic structural diagram of a base of the present disclosure.

FIG. 6 is a schematic structural diagram showing separation between a housing and a rotating disc of the present disclosure.

### IN THE FIGURES

1. projector body; 11. lens; 12. human body induction probe; 13. key area; 14. heat dissipation hole; 15. switching port; 2. base; 21. housing; 211. power socket; 212. connecting post; 213. connecting groove; 214. switching hole; 215. first limiting platform; 22. supporting rod; 221. connecting hole; 222. insertion ring; 223. threading hole; 224. mounting groove; 23. rotating disc; 231. passing hole; 232. wire passing hole; 233. second limiting platform; 24. bottom cover; 241. bolt hole; and 242. rubber pad.

### DETAILED DESCRIPTIONS OF THE EMBODIMENTS

In the present disclosure, unless otherwise explicitly specified and defined, the terms “mounting”, “connecting”, “connection”, “fixing”, etc. should be understood in a broad sense, for example, they may denote fixed connection, detachable connection, or integrated connection, denote mechanical connection or electrical connection, denote direct connection or indirect connection via an intermediate medium, or denote communication between interiors of two elements or interaction between two elements. The specific meanings of the above terms in the present disclosure may be understood on a case-by-case basis for those of ordinary skill in the art.

A further specification is made below with reference to the accompanying drawings and in conjunction with particular examples:

### Example 1

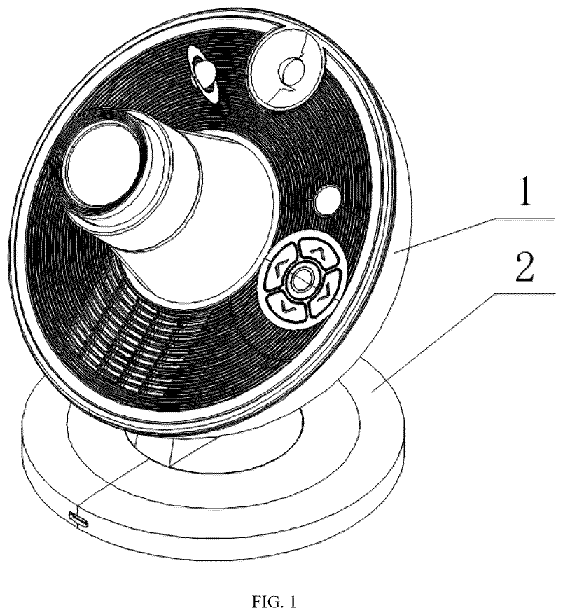

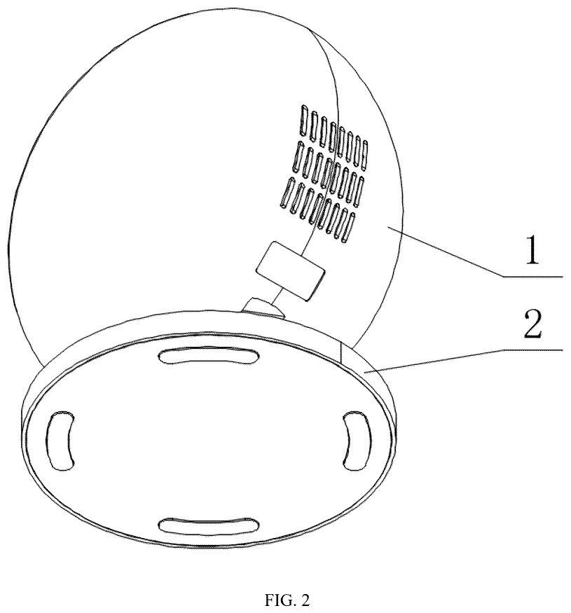

As shown in FIGS. 1, 2 and 5, a video projection lamp includes a projector body 1, a lens 11 is arranged at a middle of a front end of the projector body 1, and a projection lamp is arranged inside the lens 11. The lens 11 cooperates with the projection lamp for video projection. A base 2 is connected to a bottom end of the projector body 1, and the base 2 is to conveniently and stably support the projector body 1, such that the projector body 1 is conveniently adjusted. A pitch angle of the projector body 1 can be adjusted relative to the base 2. The base 2 includes a housing 21, a supporting rod 22, a rotating disc 23 and a bottom cover 24, where a bottom end of the supporting rod 22 passes through the housing 21 and is connected to the rotating disc 23, and the supporting rod 22 is rotationally connected to the housing 21 in coordination with a structure of the rotating disc 23, such that the supporting rod 22 conveniently carries the projector body to perform adjustment of a rotation angle. The bottom cover 24 is fixed at a bottom end of the housing 21 through bolts, and the bottom cover 24 is used for sealing an opening at the bottom end of the housing 21.

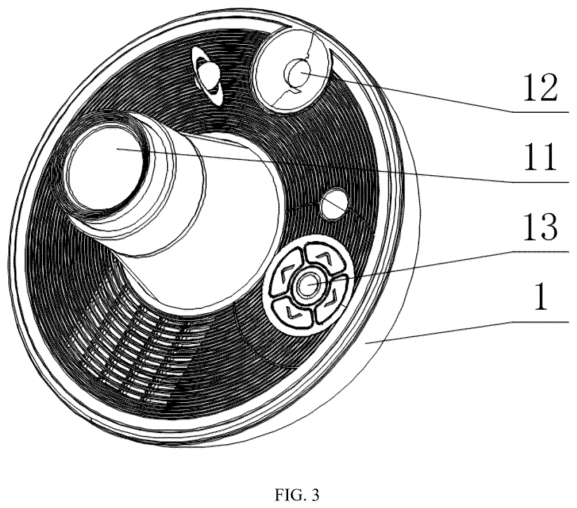

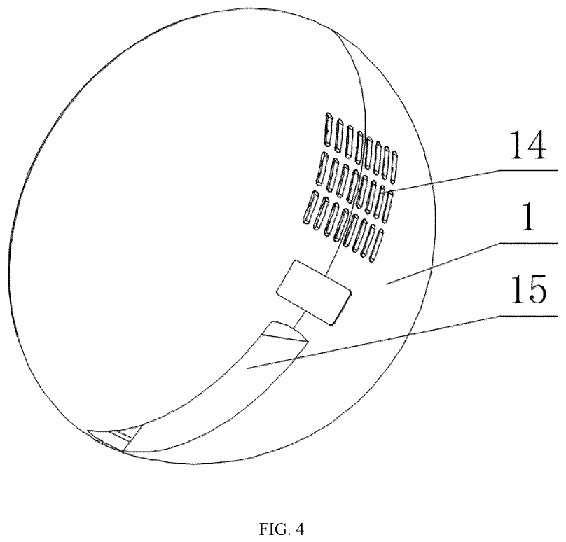

As shown in FIGS. 3 and 4, a key area 13 is arranged at one side of the front end of the projector body 1, and the key area 13 is to facilitate control over the projector body 1, such that the projector body 1 can be operated and used. Heat dissipation holes 14 are provided at a top of a back of the projector body 1, and the heat dissipation holes 14 are to make heat generated by the projector body 1 can be quickly discharged. A switching port 15 is provided at a bottom of the back of the projector body 1, and the switching port 15 is to make the projector body 1 be rotationally connected to the base 2.

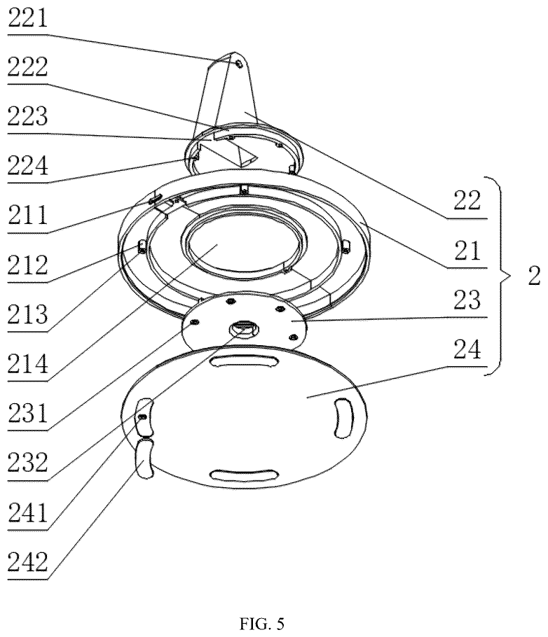

As shown in FIG. 5, a side surface of the housing 21 is provided with a power socket 211, and the power socket 211 is to make the projector body be energized. A switching hole 214 is provided at a middle of the housing 21, and the switching hole 214 is to make the supporting rod 22 be rotationally connected to the housing 21 in combination with the rotating disc 23. An inner edge of the housing 21 is provided with a plurality of connecting posts 212, the middle of each connecting post 212 is provided with a connecting groove 213, and the connecting posts 212 and the connecting grooves 213 are to make the housing 21 be connected to the bottom cover 24 through bolts. A connecting hole 221 is provided at a top end of the supporting rod 22, and the connecting hole 221 is to make the supporting rod 22 be rotationally connected to the projection lamp. A threading hole 223 is provided at a middle of the supporting rod 22, and the threading hole 223 is to make a connecting wire of the projector body 1 penetrate into the supporting rod 22 conveniently and extends out of an interior of the housing 21 from the bottom of the supporting rod 22. An insertion ring 222 is arranged at a bottom of the supporting rod 22, the insertion ring 222 passes through the switching hole 214, and a plurality of mounting grooves 224 are provided at an inner edge of the insertion ring 222. Such a structure is to make the insertion ring 222 be connected and fixed to the bottom cover 24 through bolts. A plurality of passing holes 231 are provided at the positions, aligned with the mounting grooves 224, of the rotating disc 23, bolts pass through the passing holes 231 and are in threaded connection to the mounting grooves 224, and such a structure is to make the rotating disc 23 be stably connected to the supporting rod 22. A wire passing hole 232 is provided at a middle of the rotating disc 23, and the wire passing hole 232 is to make the connecting wire of the projector body 1 be capable of passing through the rotating disc 23. A plurality of bolt holes 241 are provided at the positions, aligned with the connecting grooves 213, of the bottom cover 24, the bottom cover 24 and the housing 21 are connected through bolts, and such a structure can make the bottom cover 24 be stably connected to the supporting rod 22. Rubber pads 242 are arranged at the positions, aligned with the bolt holes 241, of a bottom of the bottom cover 24, and the rubber pads 242 can increase friction force between the base 2 and a table board.

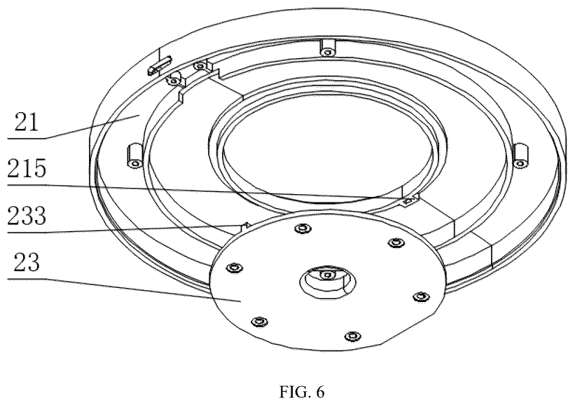

As shown in FIG. 6, a first limiting platform 215 is arranged at the position, along an edge of the switching hole 214, inside the housing 21, a second limiting platform 233 is arranged at an edge of the rotating disc 23, and the first limiting platform 215 and the second limiting platform 233 interfere with each other after the supporting rod 22 rotates by a certain angle in cooperation with the structure of the rotating disc 23, so as to solve the problem that the supporting rod 22 rotates continuously in cooperation with the structure of the rotating disc 23, causing a wire inside the threading hole 223 to be twisted, and normal use of the whole projector body 1 is ensured.

### Example 2

As shown in FIGS. 1, 2 and 5, a video projection lamp includes a projector body 1, a lens 11 is arranged at a middle of a front end of the projector body 1, and a projection lamp is arranged inside the lens 11. The lens 11 cooperates with the projection lamp for video projection. A base 2 is connected to a bottom end of the projector body 1, and the base 2 is to conveniently and stably support the projector body 1, such that the projector body 1 is conveniently adjusted. A pitch angle of the projector body 1 can be adjusted relative to the base 2. The base 2 includes a housing 21, a supporting rod 22, a rotating disc 23 and a bottom cover 24, where a bottom end of the supporting rod 22 passes through the housing 21 and is connected to the rotating disc 23, and the supporting rod 22 is rotationally connected to the housing 21 in coordination with a structure of the rotating disc 23, such that the supporting rod 22 conveniently carries the projector body to perform adjustment of a rotation angle. The bottom cover 24 is fixed at a bottom end of the housing 21 through bolts, and the bottom cover 24 is used for sealing an opening at the bottom end of the housing 21.

As shown in FIGS. 3 and 4, a key area 13 is arranged at one side of the front end of the projector body 1, and the key area 13 is to facilitate control over the projector body 1, such that the projector body 1 can be operated and used. Heat dissipation holes 14 are provided at a top of a back of the projector body 1, and the heat dissipation holes 14 are to make heat generated by the projector body 1 can be quickly discharged. A switching port 15 is provided at a bottom of the back of the projector body 1, and the switching port 15 is to make the projector body 1 be rotationally connected to the base 2.

As shown in FIG. 5, a side surface of the housing 21 is provided with a power socket 211, and the power socket 211 is to make the projector body be energized. A switching hole 214 is provided at a middle of the housing 21, and the switching hole 214 is to make the supporting rod 22 be rotationally connected to the housing 21 in combination with the rotating disc 23. An inner edge of the housing 21 is provided with a plurality of connecting posts 212, the middle of each connecting post 212 is provided with a connecting groove 213, and the connecting posts 212 and the connecting grooves 213 are to make the housing 21 be connected to the bottom cover 24 through bolts. A connecting hole 221 is provided at a top end of the supporting rod 22, and the connecting hole 221 is to make the supporting rod 22 be rotationally connected to the projection lamp. A threading hole 223 is provided at a middle of the supporting rod 22, and the threading hole 223 is to make a connecting wire of the projector body 1 penetrate into the supporting rod 22 conveniently and extends out of an interior of the housing 21 from the bottom of the supporting rod 22. An insertion ring 222 is arranged at a bottom of the supporting rod 22, the insertion ring 222 passes through the switching hole 214, and a plurality of mounting grooves 224 are provided at an inner edge of the insertion ring 222. Such a structure is to make the insertion ring 222 be connected and fixed to the bottom cover 24 through bolts. A plurality of passing holes 231 are provided at the positions, aligned with the mounting grooves 224, of the rotating disc 23, bolts pass through the passing holes 231 and are in threaded connection to the mounting grooves 224, and such a structure is to make the rotating disc 23 be stably connected to the supporting rod 22. A wire passing hole 232 is provided at a middle of the rotating disc 23, and the wire passing hole 232 is to make the connecting wire of the projector body 1 be capable of passing through the rotating disc 23. A plurality of bolt holes 241 are provided at the positions, aligned with the connecting grooves 213, of the bottom cover 24, the bottom cover 24 and the housing 21 are connected through bolts, and such a structure can make the bottom cover 24 be stably connected to the supporting rod 22. Rubber pads 242 are arranged at the positions, aligned with the bolt holes 241, of a bottom of the bottom cover 24, and the rubber pads 242 can increase friction force between the base 2 and a table board.

As shown in FIG. 6, a first limiting platform 215 is arranged at the position, along an edge of the switching hole 214, inside the housing 21, a second limiting platform 233 is arranged at an edge of the rotating disc 23, and the first limiting platform 215 and the second limiting platform 233 interfere with each other after the supporting rod 22 rotates by a certain angle in cooperation with the structure of the rotating disc 23, so as to solve the problem that the supporting rod 22 rotates continuously in cooperation with the structure of the rotating disc 23, causing a wire inside the threading hole 223 to be twisted, and normal use of the whole projector body 1 is ensured.

As shown in FIG. 3, a human body induction probe 12 is arranged at a top of the front end of the projector body 1, and the human body induction probe 12 includes but not limited to an infrared human body induction sensor, a microwave human body induction sensor, an image vision detector, etc. A control panel is arranged inside the projector body 1, and the projection lamp and the human body induction probe 12 are electrically connected to the control panel. The human body induction probe 12 is used for detecting a person approaching at a set distance, and the control panel receives a detection signal of the human body induction probe 12. When the person approaches, the control panel adjusts and reduces brightness of the projection lamp inside the lens 11 or turn off the projection lamp when necessary, so as to achieve the purpose of projecting eyes.

Working principle: when in use, a power cord is connected to the power socket 211, and then, the projector body 1 is started through the key area 13. The pitch angle of the projector body 1 is adjusted through a light source projected by the projector body 1, so as to facilitate operation of the projector body 1. Moreover, the projector body 1 can also be rotated, such that the rotation angle of the projector body 1 satisfies the use demand, and the projector body 1 is operated at an optimal angle. A detection range of the human body induction probe 12 is larger than a light projection range of the projector body 1. When the human body induction probe detects presence of a human body within the detection range, the human body induction probe automatically sends a signal to a light source control circuit in the projector body 1 to request the control circuit to reduce the brightness of the light source. When the signal showing the presence of the human body of the human body induction probe disappears within the detection range, the human body induction probe automatically sends a signal to the light source control circuit in the projector body 1 to request the control circuit to restore the brightness of the light source. When it is temporarily necessary to suspend the eye protection function in the presence of the human body, a pause protection switch can be turned on to prevent the projector body 1 from automatically reducing the brightness of the light source. This pause protection switch should be a hardware switch.

To sum up, compared with the prior art, in the present disclosure, the base 2 is mounted at the bottom of the projector body 1, such that the pitch angle of the projector body 1 can be adjusted. Moreover, an upper portion of the base 2 can rotate, such that the rotation angle of the projector body 1 can be adjusted by rotating the upper portion of the base 2, the projector body 1 can be conveniently adjusted according to the use demand, and the flexibility of the projector body 1 is greatly improved. The human body induction probe 12 is arranged on the projector body 1, such that when a person approaches the projector body 1 at a certain distance, the human body induction probe 12 will feed back a signal to a main control mechanism of the projector body 1, thereby facilitating the operation of the projector body 1.

The foregoing are merely the preferred embodiments of the present disclosure and are not intended to limit the present disclosure, and various modifications and changes may be made by those skilled in the art. Any modifications, equivalent replacements, improvements, etc. made within the spirit and principles of the present disclosure should fall within the scope of protection of the present disclosure.

What is claimed is:

1. A video projection lamp, comprising a projector body, wherein the projector body comprises a lens arranged at a front end of the projector body, a human body induction probe and a control panel arranged inside the projector body, a projection lamp is arranged inside the lens, the projection lamp and the human body induction probe are electrically connected to the control panel, the human body induction probe is used for detecting a person approaching at a set distance, and the control panel receives a detection signal of the human body induction probe, so as to adjust and reduce brightness of the projection lamp inside the lens or turn off the projection lamp.

2. The video projection lamp according to claim 1, wherein a base is connected to a bottom end of the projector body, and a pitch angle of the projector body is capable of being adjusted relative to the base.

3. The video projection lamp according to claim 2, wherein the base comprises a housing, a supporting rod, a rotating disc and a bottom cover, a bottom end of the supporting rod passes through the housing and is connected to the rotating disc, the supporting rod is rotationally connected to the housing in coordination with a structure of the rotating disc, and the bottom cover is fixed at a bottom end of the housing through bolts.

4. The video projection lamp according to claim 1, wherein a key area is arranged at one side of the front end of the projector body, heat dissipation holes are provided at a top of a back of the projector body, and a switching port is provided at a bottom of the back of the projector body.

5. The video projection lamp according to claim 3, wherein a side surface of the housing is provided with a power socket, a switching hole is provided at a middle of the housing, an inner edge of the housing is provided with a plurality of connecting posts, and the middle of each connecting post is provided with a connecting groove.

6. The video projection lamp according to claim 3, wherein a connecting hole is provided at a top end of the supporting rod, a threading hole is provided at a middle of the supporting rod, an insertion ring is arranged at a bottom of the supporting rod, the insertion ring passes through the switching hole, and a plurality of mounting grooves are provided at an inner edge of the insertion ring.

7. The video projection lamp according to claim 3, wherein a plurality of passing holes are provided at the positions, aligned with the mounting grooves, of the rotating disc, bolts pass through the passing holes and are in threaded connection to the mounting grooves, and a wire passing hole is provided at a middle of the rotating disc.

8. The video projection lamp according to claim 3, wherein a plurality of bolt holes are provided at the positions, aligned with the connecting grooves, of the bottom cover, the bottom cover and the housing are connected through bolts, and rubber pads are arranged at the positions, aligned with the bolt holes, of a bottom of the bottom cover.

9. The video projection lamp according to claim 3, wherein a first limiting platform is arranged at the position, along an edge of the switching hole, inside the housing, a second limiting platform is arranged at an edge of the rotating disc, and the first limiting platform and the second limiting platform interfere with each other after the supporting rod rotates by a certain angle in cooperation with the structure of the rotating disc, so as to solve the problem that the supporting rod rotates continuously in cooperation with the structure of the rotating disc, causing a wire inside the threading hole to be twisted.
